(19) United States
(12) Patent Application Publication
(10) Pub. No.: US 2006/0286296 A1
(43) Pub. Date: Dec. 21, 2006

(54) Method for producing a filter material

(76) Inventors: Sigrid Brandt, Traisen (DE); Günther Geiger, Rudesheim (DE); Pierre Louis Nardo, Villa di Serio (IT)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/570,950

(22) PCT Filed: Aug. 31, 2004
(86) PCT No.: PCT/EP04/09670

§ 371 Date: Mar. 7, 2006

(30) Foreign Application Priority Data
Sep. 24, 2003 (DE) 103462562

(51) Int. Cl. B05D 5/00

(52) U.S. Cl. 427/244

(57) ABSTRACT

The invention relates to a method for producing a filter material, particularly in the form of a deep filter layer, comprising a given number of native fibers made of cellulose for example, and toxically active or toxicity promoting polyaccharides provided in a suspension before being further processed to form the finished filter material. By adding specific enzymes, the respective polysaccharide is converted into a non-toxic end product or an end product having low toxicity. As a result, the respective (lipo)polysaccharide chain is cleaved at given binding points according to the enzyme used and is degraded to form a non-toxic or low toxic end product.

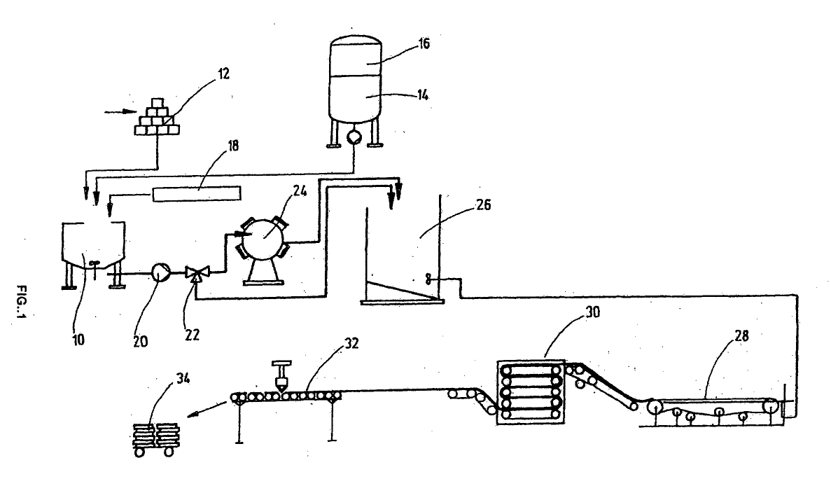

The invention relates to a method for producing a filter material, in particular one in the form of a depth filter sheet containing a prescribed number of native fibers such as ones made of a cellulose material and having a content of polysaccharides exerting a toxic effect or promoting toxicity.

Kieselguhr support layers as filter material and processes of their production have been disclosed in the prior art. In order to improve the wet-strength properties, and to prevent the swell expansions caused by drift of native fibers followed by drying, and in the kieselguhr drift filtration in filter presses used, the kieselguhr support layers consist to the amount of 20 to 50 percent by weight of the total amount of kieselguhr support layer (conceived as being dry) of polyolefin fibers with a fiber length of 0.8 to 1.2 mm. In order to produce the kieselguhr support layer the polyolefin fibers of the aqueous solution of native fibers (cellulose fibers) are added and the suspension is deposited from the fiber mixture onto a filter band and dried at the sintering temperature of the polyolefin fibers. A kieselguhr support layer is thereby obtained which, while avoiding bonding agents not permitted by food laws currently in effect both has outstanding wet-strength properties and is virtually free of swell expansion. Despite these advantages the surface bonding of the polyolefin fibers to the kieselguhr support layer is reduced and this impairs the stability, strength, and homogeneity of the filter material as a whole. Furthermore, additional properties desired, such as increase in the wet strength or the chemical resistance, may be obtained only to a very limited extent by introducing additives, because of the basic structure of known filter material.

DE 32 04 120 C2 discloses a porous support layer as filter material for a kieselguhr filter cake formed by deposit, native fibers (cellulose) and a solidification agent form a fiber structure which is wet-strong in relation to the media to be filtered. By preference the prior-art filter material consists of 20% to 50% by weight of the support layer, in relation to the dry fiber structure, of polyolefin fibers of a fiber length of 0.8 to 1.2 mm (short staple fibers) sintered both to each other and to the native fibers. In order to produce the disclosed filter material of this kind an aqueous suspension of native fibers (cellulose) and a solidification agent are deposited on a wire cloth and dehydrated to form a layered fiber structure. The fiber structure is then subjected to drying, 20 to 50 percent by weight polyolefin fibers, as determined by the extent of drying of the fiber structure, with the fiber length indicated being added to the aqueous suspension. The polyolefin fibers are then sintered in drying both to each other and to the native fibers, the drying being carried out at a temperature at which the morphological structure of the polyolefin fibers is preserved.

Since the polyolefin fibers employed have a very low melting point in the prior-art solution, fusing of the fibers during the drying and sintering process is possible, so that a reliably strong bond may not be achieved at every binding site with the native or other polyolefin fibers.

DE 100 44 218 A1 discloses a filter outfitted so as to be wet-strong, in particular a depth filter sheet of high swelling capacity, which comprises a filter matrix having open-pore cavities containing cellulose fibers as native fibers, the cellulose fibers having chemically bound polyisocyanate on their surface. Since the polyisocyanate is chemically bound in the filter matrix, the filter in question outfitted to be wet-strong is also suitable in particular for use in the food, beverage, and pharmaceutical industries.

All these disclosed filter materials, especially those in the form of depth filter sheets, have in common the feature that they use native fibers, especially ones in the form of cellulose fibers, for the base matrix structure. However, use of cellulose or cellulose fibers may not preclude the possibility that a mold fungus is present therein, the precipitation product of which exerts a toxic effect, so that the precipitation products are to be added to the group of endotoxins and pyrogens. The respective toxic precipitation products, especially those in the form of endotoxins, belong to the family of polysaccharides, the lipopolysaccharides in particular. In addition to the endotoxins referred to, the native fibers (cellulose) may have so-called glucans and glucan compounds. Recent studies have shown that the toxic effect of the endotoxins may be further increased in the organism by the presence of glucans, especially those in the form of β-glucans.

On the basis of this prior art the object of the invention is to create a process for production of a filter material which makes certain that the toxicity of any endotoxins is reduced or is entirely absent. The object as thus described is attained by means of a process specified in patent claim 1 in its entirety.

In that, as specified in the descriptive part of patent claim 1, the respective polysaccharide is converted to a non-toxic end product or one of low toxicity, it is made certain that, as a function of the enzyme used, the respective (lipo-)polysaccharide is cleaved at specified binding sites and accordingly is degraded to form non-toxic or low-toxicity end products. In order to prevent or at least reduce the glucan content of disclosed filter materials, it is claimed for the invention that provision is made such that the polysaccharide chain of the glucan of the glycoside bond is cleaved by means of the enzyme glucanase in order to obtain glucose (sugar) as harmless degradation product or end product. In particular, the 1,3-β-D-glucan which is frequently encountered may be degraded by 1,3-β-D-glucanase. The respective glucanase enzyme acts as a so-called exoenzyme from the end of the polysaccharide chain. However, suitably modified glucanase or other active substances also permit attack as so-called endoenzymes within the polysaccharide chain, this being accompanied by increased activity and thus speed of degradation of the 1,3-β-D-glucan.

The process claimed for the invention will be described in detail below on the basis of an exemplary embodiment illustrated in the drawing, in which the sole FIGURE presents in the form of a flow chart the essential process steps in relation to a production device for making the indicated filter material as a finished product.

Material in the form of cellulose 12 and water 14 from a supply tank 16 is introduced into a so-called pulper 10. A cellulose suspension is obtained as a result in the pulper 10. Endotoxins, pyrogens, and β-glucans and β-glucan compounds may also be introduced into the suspension as a result of introduction of the cellulose 12 as indicated in the foregoing. The (lipo)polysaccharide chains may be cleaved at appropriate binding sites and converted to non-toxic or low-toxicity end products through addition of an enzyme, symbolically represented by block 18. In particular, the polysaccharide 1,3-β-D-glucan may be degraded by 1,3-β-D-glucanase, the associated polysaccharide chain being cleaved at the 1,3-β-glycoside bond, glucose (sugar) being ultimately formed. The respective attack mechanism operates from the end of the chain, that is, from the direction of the effect, as exoenzymatic attack mechanism. Since the β-glucan is thus built up to form sugar as the active ingredient, normally non-toxic exposure to endotoxins has no lethal effect, something which definitely can exert a lethal effect with experimental animals (rats) after they have been exposed to β-glucan compounds.

The concentration of the enzyme employed depends on the amount of suspension obtained and normally ranges from 0.1 g to 50 g per 100 kg suspension. Depending on the enzyme employed and the enzyme activity, the reaction period may range from 5 minutes to 8 hours and the temperatures from 10° C. to the inactivation temperature of the enzyme employed, which normally ranges from 60° C. to 70° C. The pH settings may range from pH 2 to pH 11, but preferably from pH 2.3 to 6 in the acid range. The enzyme 1,3-β-D-glucanase may be obtained under the trade names ASIHA Panzym Fino G@ of the applicant Begerow. Another firm, Novozymes, markets a comparable glucanase product under the trade name AGlucanex.@

The degree of grinding of the indicated cellulose suspension is set at 18% SR, the glucan content being increased by the grinding itself as a result of mechanical treatment and enlargement of the active surface. Consequently, the efficiency of the glucan may be modified by selection of a suitable degree of grinding and the possibility may optionally be increased of creating better attack potential by the enzyme glucanase by enlarging the surface. The suspension is provided, at least partially, with other filter materials such as kieselguhr and/or perlite in a so-called refiner 24 by a pump 20 and a valve distribution unit 22 in order to obtain the necessary filter material structure. The material flows distributed by the valve distribution unit 22 are then brought together in a mixing vat 26 and taken from the latter to a Fourdinier machine 28, in which production proper of the filter material is carried out by draining of the suspension and sheet formation. The filter material produced is then moved to the float drier 30 and from it to a size cutting unit 32, in which sheet formation of the respective filter material as stackable finished product 34 is carried out. Since the drier 30 normally operates at higher temperatures, 60° C. to 70° C., the enzyme breakdown process is halted no later than at this point in time and the polysaccharide cleavage is accordingly definitively ended.

Two additional exemplary applications illustrating the efficiency of the process claimed for the invention will now be presented. In the first exemplary application 10 kg long-fiber sulfate cellulose was dissolved in 90 kg water to form a suspension and 10 g SIHA Panzym Fino G added as enzyme. Storage was then effected in the pulper 10 for 60 minutes at 30° C. The glucan content previously introduced was reduced in this way to more or less ⅓ of the previously determined amount.

Acidification of the suspension consisting of 90 kg water and 10 kg long-fiber sulfate cellulose in the pulper (10) with phosphoric acid to pH 4.5 was found to be even more effective for the purpose of reducing the glucan content. 10 g Glucanex were added as gluconase enzyme. Adjustment of the degree of grinding of the cellulose suspension was to 18° SR and storage in the pulper 10 at 50° C. for a period of 60 min, on the other hand, yielded a much more greatly reduced glucan content in the subsequent finished filterware product.

1. A method for producing a filter material, in particular one in the form of a depth filter sheet, having a specified number of native fibers, such as ones made of cellulose material, and having a content of polysaccharides exerting a toxic effect or promoting toxicity and being present in a suspension before they are additionally processed to obtain the finished filter material, characterized in that the respective polysaccharide is converted by addition of specific enzymes to a non-toxic end product or an end product of low toxicity.

2. The process as claimed in claim 1, wherein a glucan is present as polysaccharide and is converted to glucose as end product by addition of glucanase as enzyme.

3. The process as claimed in claim 2, wherein the glucan is 1,3-β-D-glucan and is introduced as 1,3-β-glucanase.

4. The process as claimed in claim 3, wherein the polysaccharide chain on the 1,3-β-D-glycoside bond is cleaved under the influence of the enzyme 1,3-β-D-glucanase so that glucose is formed.

5. The process as claimed in claim 2, wherein exoenzymes such as glucanase or substances and/or operative compounds exerting an endoenzymatic effect are employed.

6. The process as claimed in claim 1, wherein 0.1 g to 50 g of enzymes per 100 kg suspension are employed over a reaction period of 5 minutes to 8 hours and at a temperature of 10° C. to the inactivation temperature of approximately 60° C. to 70° C. in the preferably acid range of pH 2.8 to 6.

7. The process as claimed in claim 1, wherein the degree of grinding of the cellulose suspension is set at 15° to 80° SR, in particular at 18° SR.

8. The process as claimed in claim 1, wherein kieselguhr and perlite in particular are added to the suspension.

9. The process as claimed in claim 1, wherein enzymatic cleavage acting on polysaccharides, in the form of 1,3-β-D-glucan in particular, is ended for the filter material at the latest after passage of the screening machine (28) through a drier (30).

10. The process as claimed in claim 9, wherein, after passage through the drier (30), the filter material, in the form of sheets, is cut to specified sizes in a size cutting unit (32).

11. Filter material as claimed in claim 1, wherein with the addition of specific enzymes any polysaccharides present in the filter material are converted to a non-toxic end product or an end product of low toxicity.
